(19) United States
(12) Patent Application Publication
(10) Pub. No.: US 2005/0193567 A1
(43) Pub. Date: Sep. 8, 2005

(54) Utility knife

(76) Inventor: Chun-Feng Ho, Taichung City (TW)

Correspondence Address: BROWDY AND NEIMARK, P.L.L.C.;624 NINTH STREET, NW, SUITE 300, WASHINGTON, DC, 20001-5303, US

(21) Appl. No.: 11/064,963

(22) Filed: Feb. 25, 2005

(30) Foreign Application Priority Data
Mar. 3, 2004 (TW) 93203186

(51) Int. Cl. B26B 11/00

(52) U.S. Cl. 30/162; 30/125

(57) ABSTRACT

A utility knife includes a housing, a cutter holder slidably mounted in the housing for holding a cutter blade, a first compartment formed in the housing and aimed at the cutter holder, a second compartment formed in the housing for accommodating spare cutter blades, and a push block slidably mounted in the housing for pushing spare cutter blades from the second compartment into the first compartment, and a spring member provided inside the first compartment for pushing one cutter blade out of the first compartment into the cutter holder each time the cutter holder is empty.

### BACKGROUND OF THE INVENTION

1. Field of the Invention

The present invention relates to a hand tool and more specifically, to a utility knife that holds a plurality of spare cutter blades for replacement and can be easily operated to automatically replace the cutter blade.

2. Description of the Related Art

For ease of use, a utility knife is designed to have the cutter blade replaceable. After unloading of the used cutter blade, an auto shifting mechanism is controlled to load a spare cutter blade to replace the used cutter blade. However, a conventional utility knife accommodates only a limited number of spare cutter blades, for example, 5-7 pieces. When spare cutter blades are used up, a new supply of spare cutter blades should be loaded again. In order to increase the amount of spare cutter blades in a utility knife, an addition cutter compartment may be set in the housing of the utility knife. However, the user must open the cutter compartment before accessing to the storage spare cutter blades, and then attach the selected spare cutter blade to the auto shifting mechanism for enabling the auto shifting mechanism to replace the used cutter blade with the newly loaded cutter blade. When opening the cutter compartment or picking up the selected spare cutter blade from the cutter compartment, the user's hand may be injured by the cutter blade or the internal parts of the utility knife may fall out of place accidentally.

### SUMMARY OF THE INVENTION

The present invention has been accomplished under the circumstances in view. It is one object of the present invention to provide a utility knife, which holds a big number of spare cutter blades for replacement.

It is another object of the present invention to provide a utility knife, which is easy and convenient to operate.

To achieve these objects of the present invention, the utility knife comprises a housing, a cutter holder, and a push block. The housing comprises an internal chamber, a cutter blade outlet, a cutter holder slot, a sliding slot, a first compartment for holding a plurality of first spare cutter blades, a second compartment for holding a plurality of second spare cutter blades, a first spring member, which supports the first spare cutter blades in the first compartment, and a second spring member, which supports the second spare cutter blades in the second compartment. The cutter holder comprises a holder base slidably mounted in the internal chamber of the housing to hold a working cutter blade, and a suspension arm extending from the holder base to the outside of the housing through the cutter holder slot. The cutter holder is movable relative to the housing between a retracted position where the holder base holds the working cutter blade inside the housing, and an extended position where the holder base holds the working cutter blade out of the cutter blade outlet of the housing. The push block comprises a block body disposed in the internal chamber of the housing, and a knob extending from the block body to the outside of the housing through the sliding slot. The push block is movable relative to the housing between a primary position and a feeding position for carrying a predetermined number of second spare cutter blades from the second compartment to the first compartment when moving from the primary position to the feeding position.

### BRIEF DESCRIPTION OF THE DRAWINGS

FIG. 1 is a drawing showing the outer appearance of a utility knife according to a preferred embodiment of the present invention.

FIG. 2 is a front view of the utility knife according to the preferred embodiment of the present invention.

FIG. 3 is a top view of the utility knife according to the preferred embodiment of the present invention.

FIG. 4 is another top view of the utility knife according to the preferred embodiment of the present invention.

FIG. 5 is a side view of the utility knife according to the preferred embodiment of the present invention.

FIG. 6 is a side view of the cutter holder for the utility knife according to the preferred embodiment of the present invention.

FIG. 7 is a top view of the cutter holder for the utility knife according to the preferred embodiment of the present invention.

FIG. 8 is a top view of the push block for the utility knife according to the preferred embodiment of the present invention.

FIG. 9 is a front view of the retaining post for the utility knife according to the preferred embodiment of the present invention.

FIG. 10 is a top view of the retaining post for the utility knife according to the preferred embodiment of the present invention.

FIG. 11 is a schematic drawing showing the operation of the utility knife.

FIG. 12 is anther schematic drawing showing the operation of the utility knife.

FIG. 13 is still another schematic drawing showing the operation of the utility knife.

FIG. 14 is still another schematic drawing showing the operation of the utility knife.

### DETAILED DESCRIPTION OF THE INVENTION

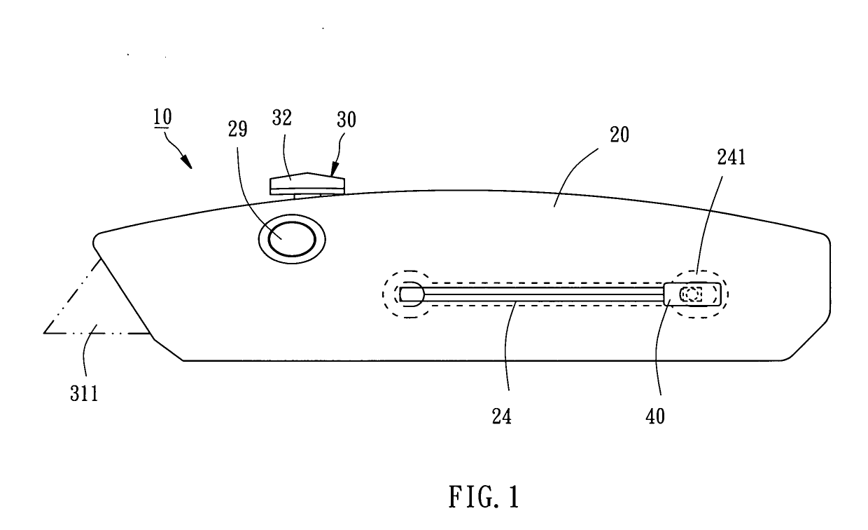

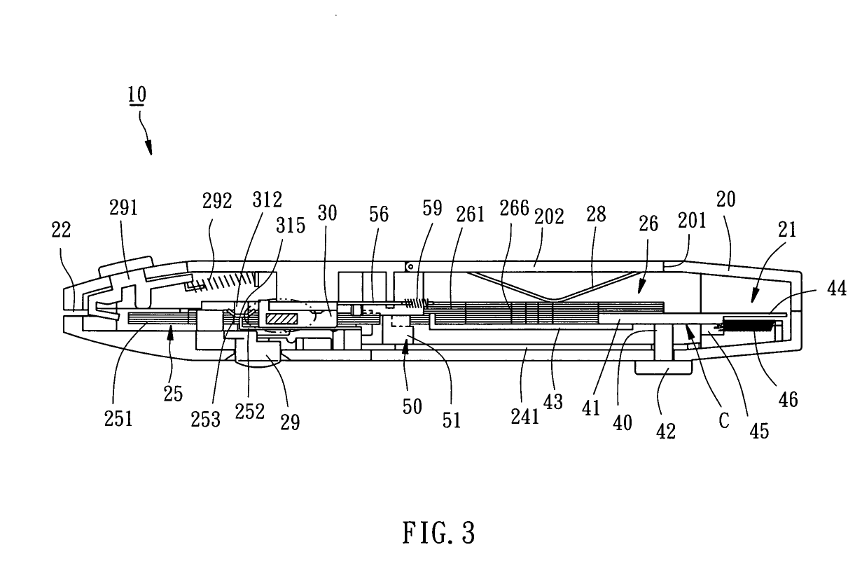

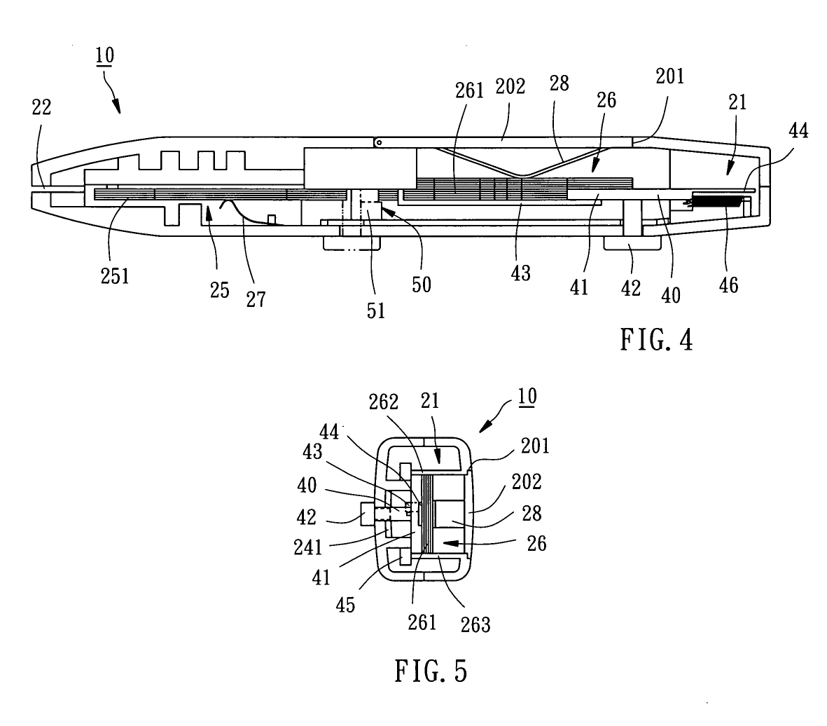

Referring to FIGS. 1-5, a utility knife 10 in accordance with the preferred embodiment of the present invention is shown comprised of a housing 20, a cutter holder 30, a push block 40, and a locking device 50.

The housing 20 comprises an internal chamber 21, a cutter blade outlet 22 at the front side, a cutter holder slot 23 at the top side, a sliding slot 24 at one lateral side, a first compartment 25, which holds a plurality of first spare cutter blades 251, a second compartment 26, which holds a plurality of second spare cutter blades 261, a first spring member 27, which supports the first spare cutter blades 251 in the first compartment 25, a second spring member 28, which supports the second spare cutter blades 261 in the second compartment 26, an opening 201 in communication between the second compartment 26 and the outside, and a cover 202, which covers the opening 201. The second spring member 28 is installed in the cover 202. Further, a dust guard 241 is installed in the housing 20 around the sliding slot 24 to stop outside dust from passing through the sliding slot 24 into the internal chamber 21 of the housing 20. The first compartment 25 and the second compartment 26 are respectively formed of ribs. For example, a top rib 262, a bottom rib 263, a back rib 264, and two front ribs 265 are respectively formed inside the housing 20, defining the second compartment 26.

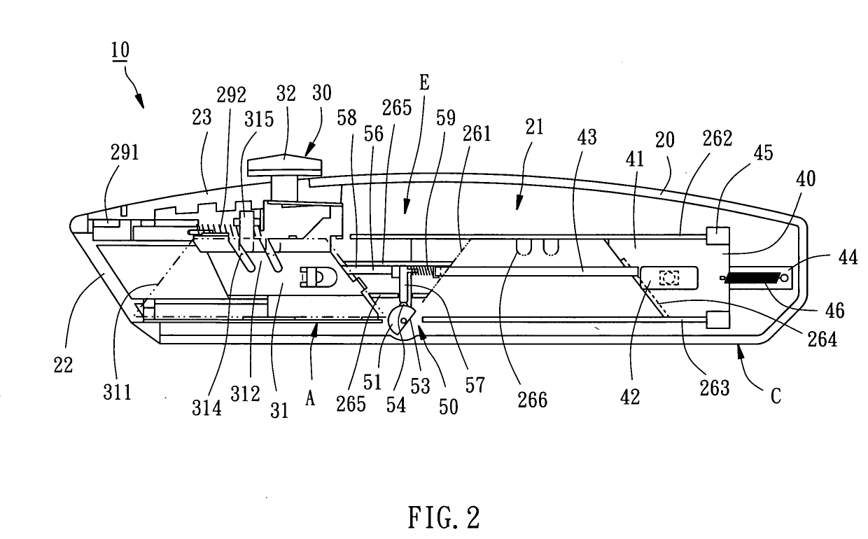

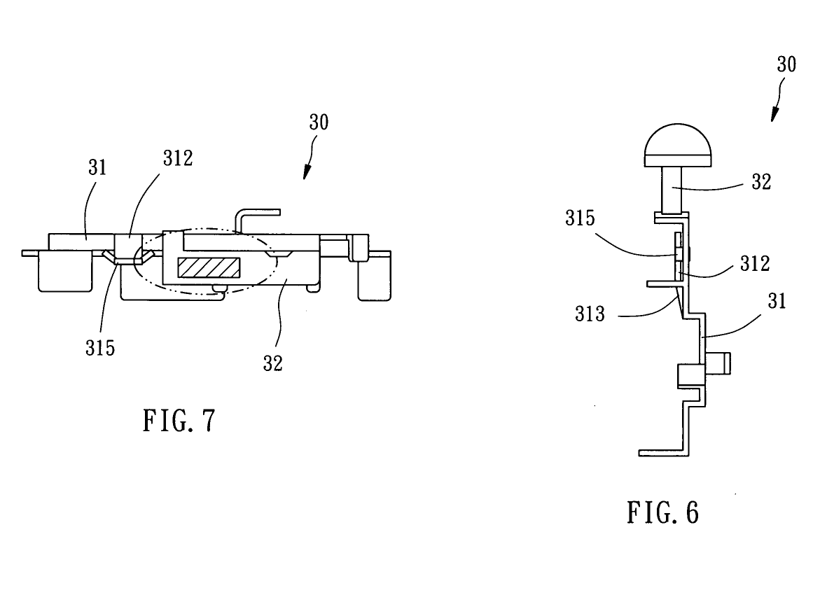

The cutter holder 30 comprises a holder base 31 slidably mounted in the internal chamber 21 of the housing 20, and a suspension arm 32 extending from the top side of the holder base 31 to the outside of the housing 20 through the cutter holder slot 23. The holder base 31 is adapted to hold a working cutter blade 311. As shown in FIGS. 6 and 7, the holder base 31 comprises a spring strip 312. The spring strip 312 has a retaining portion 313 engageable to a retaining hole 314 of the cutter blade 311, and a stop portion 315. The cutter holder 30 is slidable between a retracted position A where the cutter blade 311 is received inside the housing 20 as shown in FIG. 2, and an extended position B where the cutter blade 311 extends out of the housing 20 through the cutter blade outlet 22 as shown in GIG. 13. The housing 20 further comprises a press button 29 and a blade-releasing member 291. The user can press the press button 29 with the finger, forcing the press button 29 against the stop portion 315 of the spring strip 312. The blade-releasing member 291 is slidably mounted in the housing 20, and adapted to hook the stop portion 315 of the spring strip 312 of the cutter holder 30 for enabling the cutter blade 311 to be separated from the cutter holder 30 when the cutter holder 30 is in the extended position B. Further, a compression spring 292 is connected between the housing 20 and the blade-releasing member 291 to impart a forward prestress to the blade-releasing member 291.

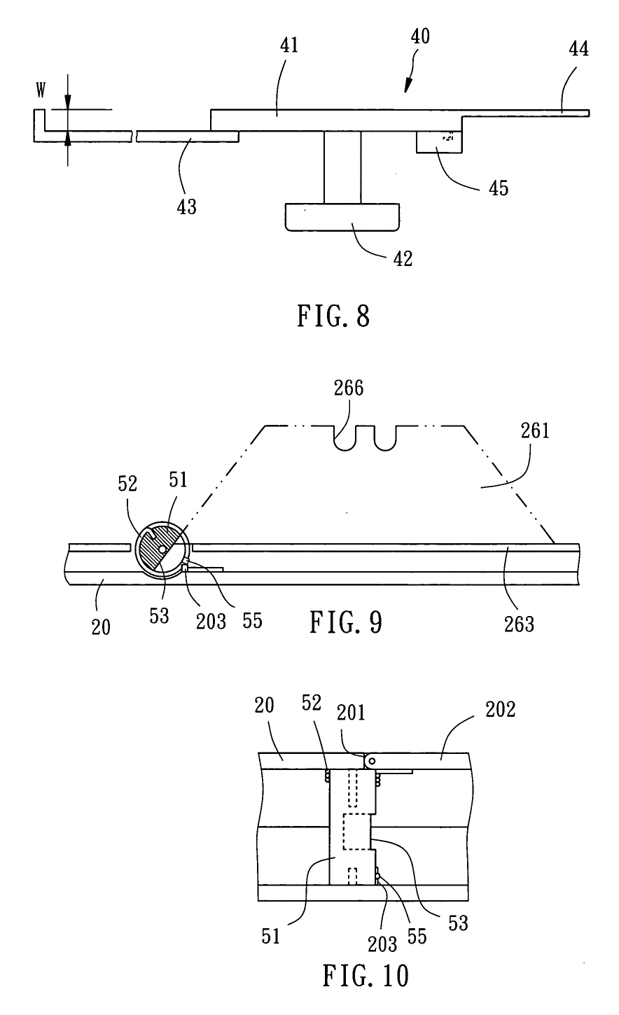

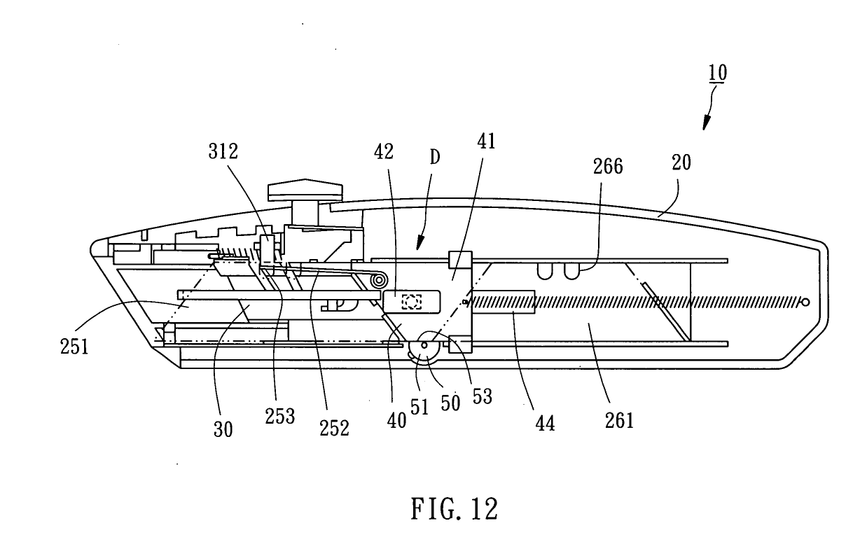

The push block 40 comprises a block body 41 slidably coupled between the top rib 262 and the bottom rib 263, a knob 42 extending from the block body 41 to the outside of the housing 20 through the sliding slot 24, a hook 43 forwardly extending from the front side of the block body 41 and hooked on the front ends of the second spare cutter blades 261, a tail 44 backwardly extending from the rear side of the block body 41, and two bearing portions 45 respectively disposed at the top and bottom sides of the block body 41 and respectively stopped at the top rib 262 and the bottom rib 263. The push block 40 is movable between a primary position C and a feeding position D (see FIG. 12). The block body 41 has a certain width W, as shown in FIG. 8. When moving the push block 40 from the primary position C to the feeding position D, the block body 41 will push a predetermined number (for example, 5) of the second spare cutter blades 261 out of the second compartment 26 to the first compartment 25. Further, a tensile spring 46 is connected between the push block 40 and the housing 20 to impart a prestress to return the push block 40 to the primary position C. Further, a hook 252 is provided inside the first compartment 25 of the housing 20 and adapted to hook the retaining hole 253 of each of the first spare cutter blades 251.

The locking device 50 is installed in the internal chamber 21 between the first compartment 25 and the second compartment 26, comprising a retaining post 51 pivotally mounted in the housing 20, an L-shaped support member 56 slidably mounted in the housing 20, and a spring member 59 stopped between the housing 20 and the support member 56. As shown in FIGS. 9 and 10, a torsional spring 52 is provided at one end of the retaining post 51 to impart a clockwise rotary prestress to the retaining post 51. The retaining post 51 has a cut face 53 stopped against the front ends of the second spare cutter blades 261. The support member 56 has a first end 57 stopped against a first protruding block 54 of the retaining post 51, and a second end 58 stopped against the cutter holder 30. The retaining post 51 further comprises a second protruding block 55 stopped against a stopping portion 203 of the housing 20 to limit the turning angle of clockwise rotation of the retaining post 51.

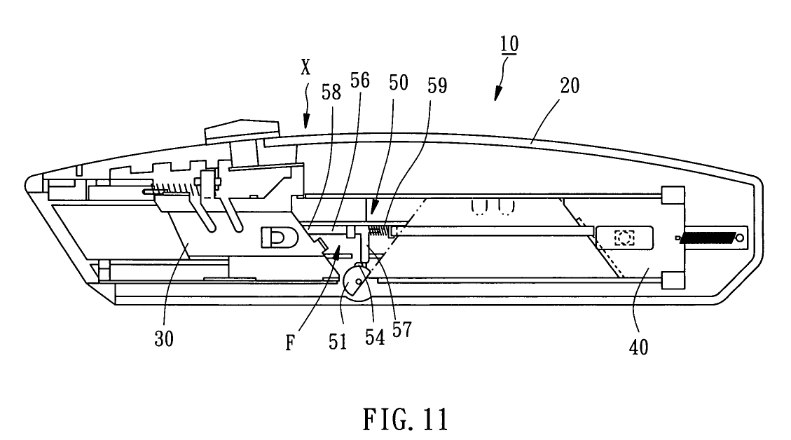

The operation of the present invention is outlined hereinafter with reference to FIG. 2. After mounting of the working cutting blade 311 in the holder base 31, the rear end of the working cutting blade 311 is stopped against the front ribs 265, and the cutter holder 30 is in the retracted position A. At this time, the locking device 50 is in the locking position E, i.e., the first end 57 of the support member 56 is still maintained stopped against the first protruding block 54 of the retaining post 51 to stop the retaining post 51 from rotation, and therefore the second spare cutter blades 261 can not be pushed by the push block 40 into the first compartment 25. When the cutter holder 30 is empty, as shown in FIG. 11, the cutter holder 30 can be moved from the retracted position A to a final position X to push the locking device 50 to the unlocking position F, i.e., the cutter holder 30 can be moved backwards to push the second end 58 of the support member 56, causing the support member 56 to disengage the first end 57 from the first protruding block 54 of the retaining post 51, and at this time the retaining post 51 is rotatable for enabling the second spare cutter blades 261 to be pushed by the push block 40 into the first compartment 25.

Referring to FIG. 12, when the locking device 50 is in the unlocking position F, the user can push the knob 42 to move the push block 40 forwards, thereby causing the block body 41 to push a predetermined number (for example, 5) of the second spare cutter blades 261 out of the second compartment 26 to the first compartment 25. In order to prevent the retaining portion 313 of the spring strip 312 from hindering forward movement of the second spare cutter blades 261, the user must simultaneously press the press button 29 against the stop portion 315 of the spring strip 312. At this time, the retaining post 51 will rotate counter-clockwise to move the cut face 53 to the parallel position relative to the moving direction of the second spare cutter blades 261. During forward movement of the second spare cutter blades 261, the hook 252 will be curved upward for letting the second spare cutter blades 261 pass. After the second spare cutter blades 261 have been set into position, the hook 252 is returned to its former shape and hooked in the retaining hole 266 of the second spare cutter blades 261 (at this time, the second spare cutter blades become the first spare cutter blades), and the process to deliver the cutter blades from the second compartment 26 to the first compartment 25 is done. After delivery of the cutter blades from the second compartment 26 to the first compartment 25, the tail 44 of the push block 40 is still suspending in the second compartment 26 to stop the rest second spare cutter blades 261 in the second compartment 26 against the spring power of the second spring member 28, preventing the formation of a barrier to the return stoke of the push block 40 to the primary position C.

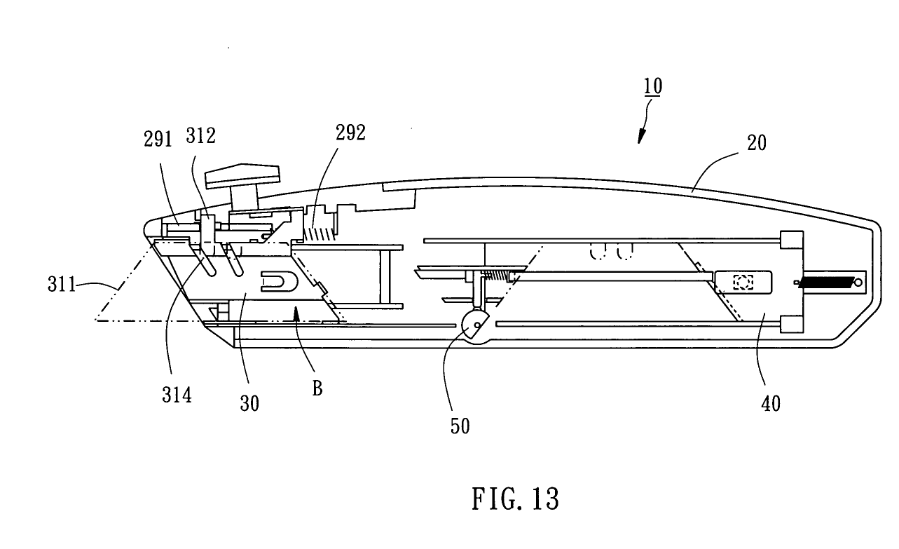

Thereafter, the cutter holder 30 is moved slightly forwards from the final position X to the retracted position A. At this time, the first spring member 27 pushes one first spare cutter blade 251 to the cutter holder 30, thereby forming a new working cutter blade 311. By means of the suspension arm 32, the user can move the cutter holder 30 and the working cutter blade 311 to the extended position B as shown in FIG. 13, to extend the working cutter blade 311 out of the cutter blade outlet 22 of the housing 20 for cutting.

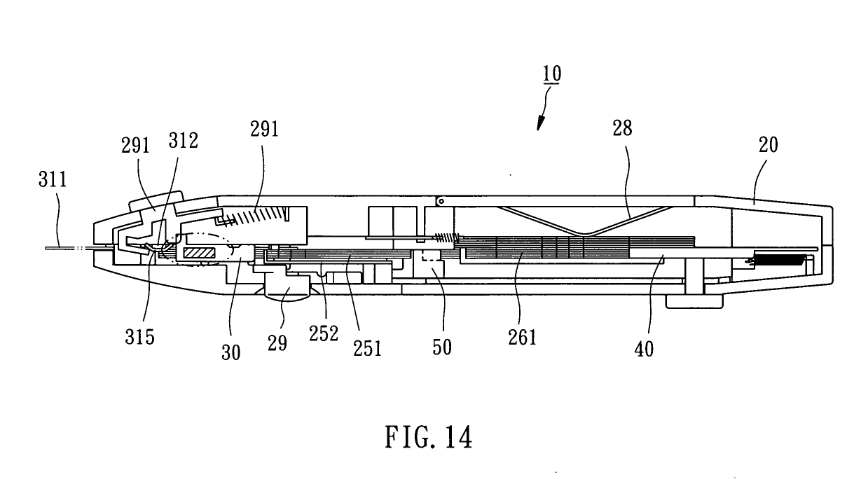

Referring to FIG. 14, when wishing to change the working cutter blade 311, pull the blade-releasing member 291 backwards to stretch the stop portion 315 of the spring strip 312, for enabling the working cutter blade 311 to be disengaged from the constraint of the retaining portion 313, and at this time the user can remove the working cutter blade 311 from the cutter holder 30. After the cutter holder 30 has been returned to the retracted position A, the first spring member 27 pushes one first spare cutter blade 251 into the cutter holder 30, and therefore the working cutter blade changing operation is done. When all first spare cutter blades 251 are used up, the hook 43 of the push block 40 does no work, and the tensile spring 46 immediately pulls the push block 40 to the primary position C as shown in FIG. 2.

When the cutter holder 30 is empty, the cutter holder 30 is moved backwards to the finial position X as shown in FIG. 11. At this time, the locking device 50 is in the unlocking position F for enabling the second spare cutter blades 261 to be moved forwards from the second compartment 26 to the first compartment 25.

As indicated above, the utility knife 10 accommodates a plurality of spare cutter blades for a replacement, and the replacement of the cutter blade can easily be done by means of operating the knob 42, the press button 29, the cutter holder 31 and the blade-releasing member 291. Because it is not necessary to open the housing 20 during a cutter blade replacement operation, the present invention is easy to use.

Although a particular embodiment of the invention has been described in detail for purposes of illustration, various modifications and enhancements may be made without departing from the spirit and scope of the invention. Accordingly, the invention is not to be limited except as by the appended claims.

1. A utility knife comprising:
a housing having an internal chamber, a cutter blade outlet, a cutter holder slot, a sliding slot, a first compartment for holding a plurality of first spare cutter blades, a second compartment for holding a plurality of second spare cutter blades, a first spring member, which supports said first spare cutter blades in said first compartment, and a second spring member, which supports said second spare cutter blades in said second compartment;
a cutter holder having a holder base slidably mounted in the internal chamber of said housing to hold a working cutter blade, and a suspension arm extending from said holder base to the outside of said housing through said cutter holder slot, said cutter holder being movable relative to said housing between a retracted position where said holder base holds the working cutter blade inside said housing and an extended position where said holder base holds the working cutter blade out of the cutter blade outlet of said housing, and
a push block having a block body disposed in the internal chamber of said housing and a knob extending from said block body to the outside of said housing through said sliding slot, said push block being movable relative to said housing between a primary position and a feeding position for carrying a predetermined number of second spare cutter blades from said second compartment to said first compartment when moving from said primary position to said feeding position.

2. The utility knife as claimed in claim 1, further comprising a locking device installed in said housing between said first compartment and said second compartment and switchable between a locking position and an unlocking position, wherein when said cutter holder holds a working cutter blade, said locking device is in said locking potion to lock said second spare cutter blades in said second compartment; when said cutter holder is empty, said cutter holder is able to be moved from said retracted position to a final position to push said locking device from said locking position to said unlocking position for allowing said second spare cutter blades to be moved to said first compartment.

3. The utility knife as claimed in claim 2, wherein said locking device comprises a retaining post pivotally mounted in said housing, a support member slidably mounted in said housing, and a spring member stopped between said housing and said support member, said retaining post having one end fastened to a torsional spring and a cut face stopped against front ends of the second spare cutter blades in said second compartment, said support member having a first end stopped against said retaining post and a second end stopped against said cutter holder.

4. The utility knife as claimed in claim 1, wherein said housing further comprises an opening in communication with said second compartment, and a cover closing said opening; said second spring member of said housing is provided at said cover.

5. The utility knife as claimed in claim 1, wherein said push block comprises a hook extending from said block body for hooking ends of the second spare cutter blades in said first compartment.

6. The utility knife as claimed in claim 1, further comprising a hook installed in said housing for hooking in a retaining hole of the first spare cutter blade in said first compartment.

7. The utility knife as claimed in claim 1, wherein said cutter holder comprises a spring strip for engaging into a retaining hole of the working cutter blade loaded on said cutter holder; said housing comprises a press button pressable against the spring strip of said cutter holder.

8. The utility knife as claimed in claim 1, wherein said cutter holder comprises a spring strip for engaging into a retaining hole of the working cutter blade loaded on said cutter holder; said housing further comprises a blade-releasing member, said blade-releasing member being supported on a compression spring inside said housing and hookable on the spring strip of said cutter holder.

9. The utility knife as claimed in claim 1, further comprising a dust guard installed in said housing around said sliding slot to stop outside dust from passing through said sliding slot into the internal chamber of said housing.
